(19) United States
(12) Patent Application Publication
(10) Pub. No.: US 2014/0244403 A1
(43) Pub. Date: Aug. 28, 2014

(54) ADVERTISING CHARGE ADJUSTING DEVICE

(71) Applicant: YAHOO JAPAN CORPORATION, Tokyo (JP)

(72) Inventors: Shunsaku ASANO, Tokyo (JP); Toru TAKATA, Tokyo (JP); Takeshi AMANO, Tokyo (JP); Yuki TAKI, Tokyo (JP)

(73) Assignee: YAHOO JAPAN CORPORATION, Tokyo (JP)

(21) Appl. No.: 14/173,502

(22) Filed: Feb. 5, 2014

(30) Foreign Application Priority Data
Feb. 28, 2013 (JP) 2013-039935

(51) Int. Cl. G06Q 30/02

(52) U.S. Cl. CPC G06Q 30/0275
USPC 705/14.71

(57) ABSTRACT

An advertising charge adjusting device is configured to set a minimum delivery price which determines a lower limit of a bid price. The advertising charge adjusting device includes a minimum delivery price calculating unit configured to calculate the minimum delivery price for each targeting element, based on bid information for using a targeting function and bid information for not using the targeting function, pieces of bid information being submitted by a plurality of advertisers.

### CROSS-REFERENCE TO RELATED APPLICATIONS

The present application claims priority to and incorporates by reference the entire contents of Japanese Patent Application No. 2013-039935 filed in Japan on Feb. 28, 2013.

### BACKGROUND OF THE INVENTION

1. Field of the Invention

The present invention relates to a technique for delivering advertising information through a network, such as the Internet.

2. Description of the Related Art

To provide advertising information, there are various delivery types, such as a type of providing advertising content which matches a searched keyword input by a user (search-based advertising), and a type of providing advertising content which matches contents of a displayed page (content-based advertising).

Also, there is a function called targeting which provides advertising content only to users having a particular attribute. The targeting is used either in combination with the above types of delivery or independently (see, for example, Japanese Patent Application Laid-open No. 2011-22675). For example, it is possible to deliver the advertising content only to female users, users in a particular age group, or a combination thereof.

While a delivery section (advertising space) for displaying advertising content is limited, there is a plurality of (great number of) pieces of advertising content desired to be displayed by advertisers. Thus, when a competition occurs, the advertising content to be delivered is determined in an auction-style, based on bid prices set by the advertisers in advance.

As described above, in such an advertising information providing system, the advertising content is determined based on the bid price. Normally, an appropriate bid price is set. If other conditions are similar, the bid price becomes higher when a targeting is performed (targeting) than when the targeting is not performed (non-targeting).

However, since the bid price can be freely set by the advertiser, there is advertising content, the bid price of which is set much lower than the appropriate market rate.

In such a case, normally, advertising content with a higher appropriate bid price is delivered and advertising content with a lower bid price is not delivered.

However, due to factors such as budget exhaustion of the advertising content which is bid with the appropriate bid price, the advertising content with a bid price which is much lower, for using the targeting function, than the proper market rate can be luckily delivered.

Such a situation is not welcomed by the advertisers who submit advertisements appropriately. If the situation lasts, on a long-term basis, the development of an Internet advertising service may be impeded.

### SUMMARY OF THE INVENTION

It is an object of the present invention to at least partially solve the problems in the conventional technology.

According to one aspect of an embodiment, an advertising charge adjusting device is configured to set a minimum delivery price which determines a lower limit of a bid price. The advertising charge adjusting device includes a minimum delivery price calculating unit configured to calculate the minimum delivery price for each targeting element, based on bid information for using a targeting function and bid information for not using the targeting function, pieces of bid information being submitted by a plurality of advertisers.

According to another aspect of an embodiment, an advertising charge adjusting method is for setting a minimum delivery price which determines a lower limit of a bid price. The advertising charge adjusting method includes calculating the minimum delivery price for each targeting element, based on bid information for using a targeting function and bid information for not using the targeting function, both pieces of bid information being submitted by a plurality of advertisers.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a system configuration example according to an embodiment of the present invention;

FIG. 2 is a diagram illustrating a data structure example of an advertising DB;

FIG. 3 is a diagram illustrating a data structure example of an MMR table;

FIG.4 is a diagram illustrating a data structure example of a user DB;

FIG. 5 is a sequence diagram illustrating a processing example of the embodiment;

FIG. 6 is a flowchart illustrating a processing example of generating an MMR table;

FIG. 7 is a diagram illustrating an example of distribution of bid prices;

FIG. 8 is a flowchart illustrating a processing example of a combined MMR calculation; and

FIG. 9 is a diagram illustrating an example of the combined MMR calculation.

### DETAILED DESCRIPTION OF THE PREFERRED EMBODIMENTS

In the following, a preferred embodiment of the present invention will be described.

Configuration

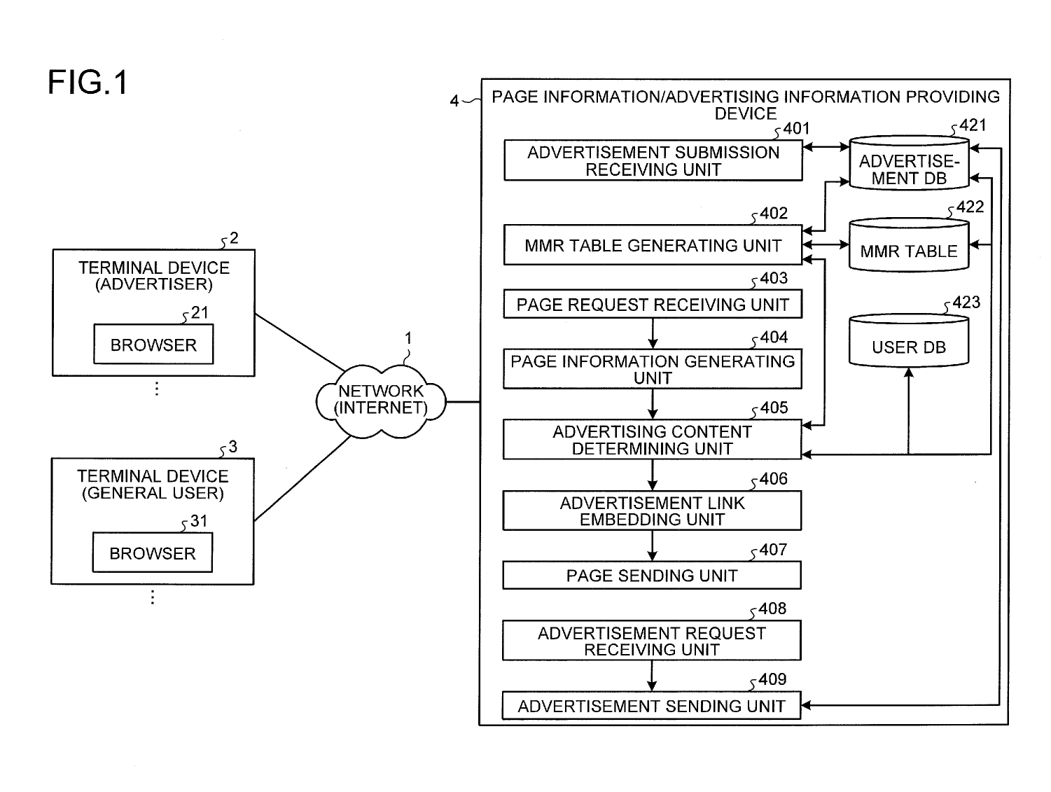

FIG. 1 is a diagram illustrating a system configuration example according to an embodiment of the present invention.

In FIG. 1, multiple terminal devices 2 and 3, such as smart phones, cell phones, and personal computers (PC) are connected to a network 1 such as the Internet. The terminal devices 2 and 3 are operated by advertisers and general users. The terminal devices 2 and 3 include general browsers (web browsers) 21 and 31, respectively. The browsers 21 and 31 include functions of requesting/receiving/displaying page data written in a language such as a Hyper Text Markup Language (HTML), and sending form data, by following a Hyper Text Transfer Protocol (HTTP) and the like which are standard protocols of the Internet.

In addition, a page information/advertising information providing device 4 is connected to the network 1. The page information/advertising information providing device 4 receives a submission of an advertisement in response to a request from the terminal device 2 operated by an advertiser, and provides page information and advertising information in response to a request from the terminal device 3 operated by a general user.

The page information/advertising information providing device 4 includes, as functional units, an advertisement submission receiving unit 401, a Minimum Market Reserve (MMR) table generating unit 402, a page request receiving unit 403, a page information generating unit 404, an advertising content determining unit 405, an advertisement link embedding unit 406, a page sending unit 407, an advertisement request receiving unit 408, and an advertisement sending unit 409.

These functional units are achieved by a computer program which is executed on hardware resources, such as a central processing unit (CPU), a read only memory (ROM), and a random access memory (RAM) of a computer which configures the page information/advertising information providing device 4. The functional units are not necessarily arranged in a single computer and may be spread on a plurality of computers, if necessary.

Also, an advertisement database (DB) 421, an MMR table 422, and a user DB 423 are provided as databases and the like which are used by the page information/advertising information providing device 4. The databases and the like systematically hold prescribed data on a storage medium such as a hard disk drive (HDD) in the computer which configures the page information/advertising information providing device 4. Note that the advertisement DB 421, the MMR table 422, and the user DB 423 are not necessarily arranged in the page information/advertising information providing device 4 and may be arranged in another device.

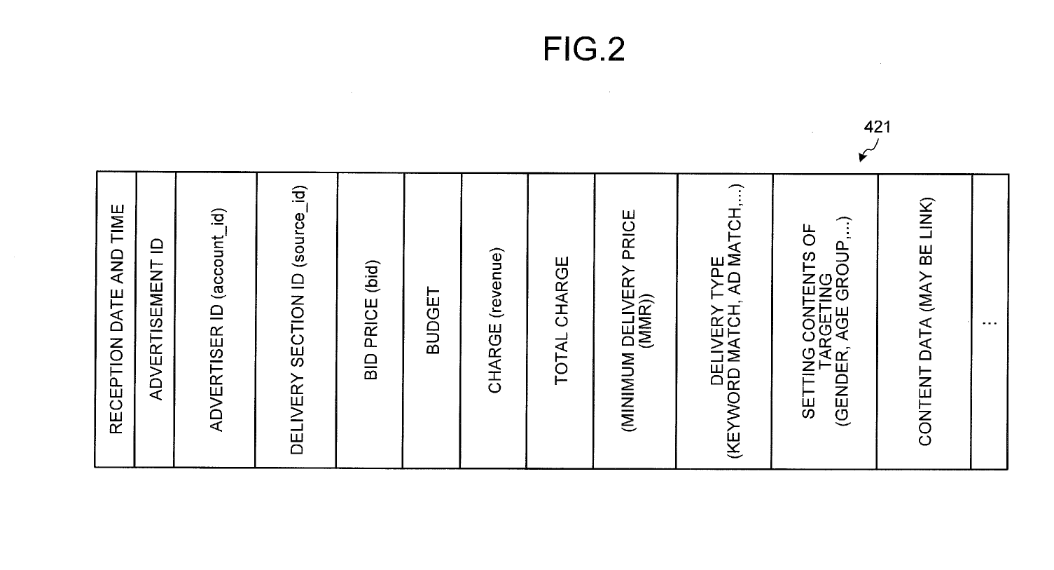

FIG. 2 is a diagram illustrating a data structure example of the advertisement DB 421, which includes fields such as “reception date and time”, “advertisement ID”, “advertiser ID (account_id)”, “delivery section ID (source_id)”, “bid price (bid)”, “budget”, “charge (revenue)”, “total charge”, “minimum delivery price (MMR)”, “delivery type”, “setting contents of targeting”, and “content data”.

The “reception date and time” is information of date and time at which a submission is received. The “advertisement ID” is information for specifying advertising content. The “advertiser ID (account_id)” is information for specifying an advertiser. The “delivery section ID (source_id)” is information for specifying a page including an advertising space on which advertising content is displayed.

The “bid price (bid)” is set by an advertiser as a price which the advertiser can pay for a delivery of the advertising content (a price for one click in the case of a click-based charge). The “budget” is a price set by the advertiser as an upper limit of a total charge. When the total charge reaches the budget, the advertising content is excluded from targets of delivery. The “charge (revenue)” is a price which is set on the occasion of delivering advertising content, when the advertising content is determined in an auction from a plurality of pieces of advertising content, the conditions of which are competing. The “charge (revenue)” is determined, for example, by a second price auction (method in which the highest bidder wins a bid but a bid price to be paid (charge) is the second highest bid price). The “total charge” is a total value of the charge. The “minimum delivery price (MMR)” is a field for holding a minimum delivery price (combined MMR) which is a price in the case of setting a plurality of targeting elements, by associating the minimum delivery price (combined MMR) with advertising data.

The “delivery type” is information set by the advertiser, which indicates a method how the advertising content is determined. Examples of the “delivery type” include a search-based advertising (keyword match) and a content-based advertising (ad match). The “setting contents of targeting” is information set by the advertiser, which indicates a targeting element in the case of using the targeting function. Examples of the targeting element include age groups, such as the 12-14 age group, and gender, such as “male” and “female”. The “content data” is main data of the advertising content or link information of a place where the main data is stored.

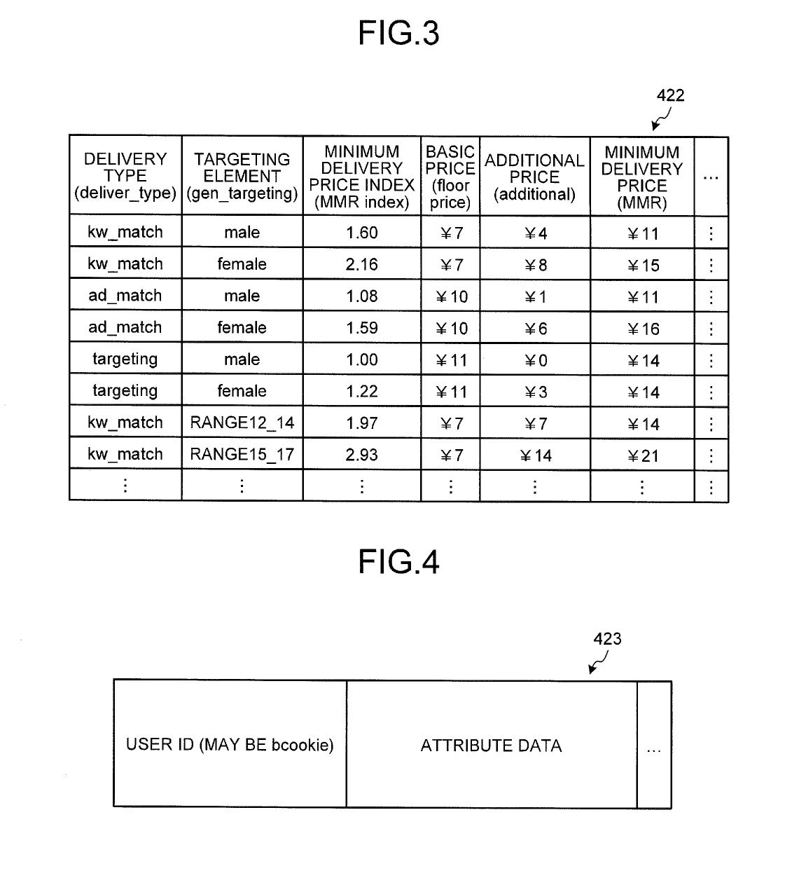

FIG. 3 is a diagram illustrating a data structure example of the MMR table 422, which includes fields such as “delivery type (deliver_type)”, “targeting element (gen_targeting)”, “minimum delivery price index (MMR index)”, “basic price (floor price)”, “additional price (additional)”, and “minimum delivery price (MMR)”.

The “delivery type (deliver_type)” is information which indicates a method how advertising content is determined. Examples of the “delivery type (deliver_type)” include “kw_match” (keyword match) and “ad_match” (ad match). A delivery type “targeting” indicates that the keyword match and the ad match are not performed and that only the targeting function is used. The “targeting element (gen_targeting)” is an attribute and the like of users narrowed down by the targeting function. The “targeting element (gen_targeting)” includes, for example, “male” (male), “female” (female), and “RANGE12_{—}14” (ages from 12 to 14).

The “minimum delivery price index (MMR index)” is an index which determines the minimum delivery price (MMR). The “minimum delivery price index (MMR index)” is calculated, for each targeting element, from distribution tendencies of bid prices in the cases of performing the targeting and not performing the targeting. The “basic price (floor price)” indicates, for each delivery type (deliver_type), a basic price which does not include a price for the targeting function. The “basic price (floor price)” is calculated from the distribution tendency of bid prices in the case of not performing the targeting. The “additional price (additional)” indicates an additional price of a prescribed targeting element, for each delivery type (deliver_type). The “minimum delivery price (MMR)” sets a lower limit of a bid price with which advertising content is not delivered. Details of the calculations will be described later.

FIG. 4 is a diagram illustrating a data structure example of the user DB 423, which includes fields such as “user ID”, and “attribute data”. The “user ID” is information for specifying a user, which includes, for example, a member ID and a bcookie. The member ID makes it possible to specify the user in detail. The bcookie (written as cookie information of a browser in a first access and referred to in the following accesses) makes it possible to specify that the access is from the same browser. The “attribute data” is information which indicates gender, an age group, a taste, and the like of the user.

Referring back to FIG. 1, the advertisement submission receiving unit 401 of the page information/advertising information providing device 4 includes a function of receiving a submission of an advertisement in response to a request from the browser 21 of the terminal device 2 operated by an advertiser, and registering prescribed fields in the advertisement DB 421 (FIG. 2).

The MMR table generating unit 402 operates periodically or operates by following instructions of an operator. The MMR table generating unit 402 includes a function of referring to the advertisement DB 421 for data about a bid, and generating the MMR table 422 (FIG. 3). Details of the processing will be described later.

The page request receiving unit 403 includes a function of receiving a page browsing request from the browser 31 of the terminal device 3 operated by a general user.

The page information generating unit 404 includes a function of generating page information corresponding to the received page browsing request. An advertising space is included in the generated page.

The advertising content determining unit 405 includes a function of referring to the advertisement DB 421, the MMR table 422, and the user DB 423 based on the page information generated by the page information generating unit 404, performing an auction for advertising content, conditions of which are competing, and determining the advertising content to be delivered.

The advertisement link embedding unit 406 includes a function of embedding a link of the advertising content determined by the advertising content determining unit 405 into an advertising space on the page generated by the page information generating unit 404. The link is, for example, a URL of the page information/advertising information providing device 4, to which the advertisement ID is added as a parameter. Note that the main data of the advertising content may be embedded in the page instead of the link.

The page sending unit 407 includes a function of sending the page information to a requester, that is, the browser 31 of the terminal device 3.

The advertisement request receiving unit 408 includes a function of receiving a request for the advertising content from the browser 31 of the terminal device 3 in a process of rendering a screen from the page information, based on the link embedded in the advertising space. When the main data of the advertising content is embedded in the advertising space, the request for the advertising content is not performed.

When the advertisement request receiving unit 408 receives the request for the advertising content, the advertisement sending unit 409 sends the data of the corresponding advertising content to the requester, that is, the browser 31 of the terminal device 3.

Operation

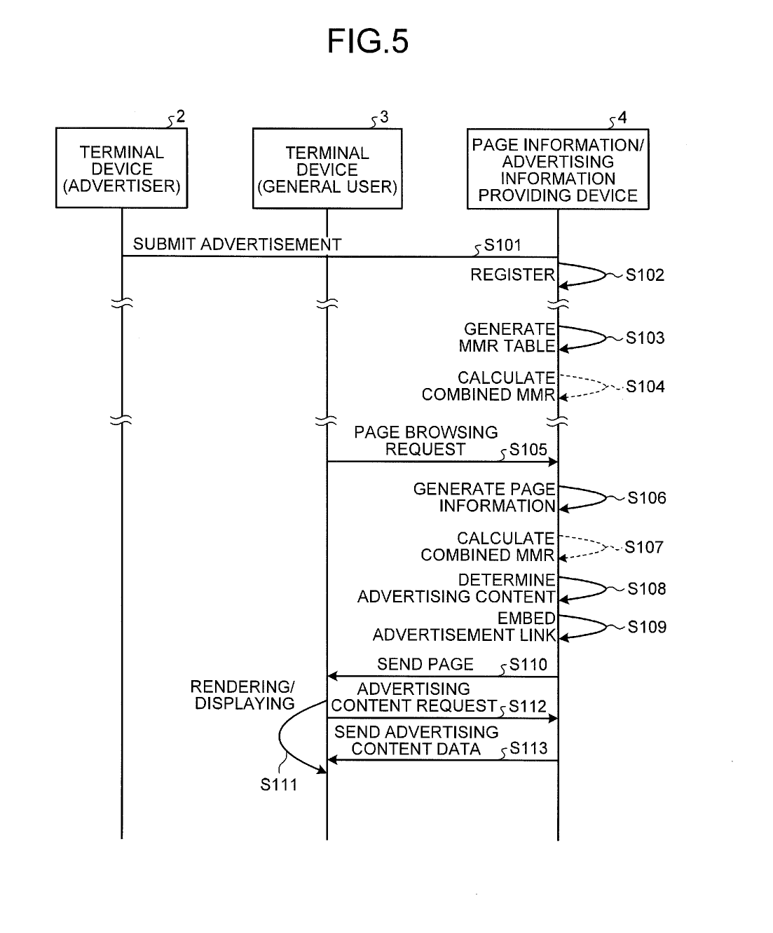

FIG. 5 is a sequence diagram illustrating a processing example of the embodiment.

In FIG. 5, when an advertisement is submitted in response to a request from the browser 21 of the terminal device 2 operated by an advertiser (step S101), the advertisement submission receiving unit 401 of the page information/advertising information providing device 4 registers prescribed fields in the advertisement DB 421 (FIG. 2) (step S102). That is, the advertisement submission receiving unit 401 registers current date and time as reception date and time, issues a unique advertisement ID, registers an advertiser ID based on, for example, information of a login performed at the time of the submission, and registers, according to contents input by the advertiser, a delivery section ID, a bid price, a budget, a delivery type, setting contents of targeting, and content data.

Then, the MMR table generating unit 402 operates periodically or operates by following instructions of an operator, refers to the advertisement DB 421 for data about the bid, and generates the MMR table 422 (FIG. 3) (step S103). Details of the processing will be described later.

Next, when the combined MMR is calculated in advance, the MMR table generating unit 402 refers to the advertisement DB 421 and the MMR table 422, calculates the combined MMR, and registers the calculated result as a part of the MMR table 422 or by associating the calculated result with the advertising data (step S104). Details of the processing will be described later.

After that, when a page browsing request is made by the browser 31 of the terminal device 3 operated by a general user, and received by the page request receiving unit 403 of the page information/advertising information providing device 4 (step S105), the page information generating unit 404 generates page information corresponding to the received page browsing request (step S106).

Next, when the combined MMR is calculated at the same time as the determination of the advertisement, the MMR table generating unit 402 refers to the advertisement DB 421 and the MMR table 422, and calculates the combined MMR. If the calculated result is to be kept, the MMR table generating unit 402 registers the calculated result as a part of the MMR table 422 or by associating the calculated result with the advertising data (step S107). Details of the processing will be described later.

Then, the advertising content determining unit 405 refers to the advertisement DB 421, the MMR table 422, and the user DB 423, based on the page information generated by the page information generating unit 404. The advertising content determining unit 405 performs an auction for the advertising content, conditions of which are competing, and determines the advertising content to be delivered (step S108).

That is, based on the delivery section ID corresponding to the page generated by the page information generating unit 404, the advertising content determining unit 405 extracts, from the advertisement DB 421 (FIG. 2), the advertising content, the total charge of which is under the budget and the bid price of which is not under any of the following prices: the minimum delivery prices (MMR) of a corresponding targeting element or the combination of the targeting elements in the MMR table 422; the minimum delivery price (MMR) associated with the advertising data; and the minimum delivery price (MMR) calculated shortly beforehand. Then, based on a searched keyword which is received by the page request receiving unit 403 in the case of a searched result page, a word which is included in the page information generated by the page information generating unit 404, and an attribute and the like which are obtained from the user DB 423 according to the user ID recognized by the page request receiving unit 403, the advertising content determining unit 405 narrows down the advertising content to be a candidate for the delivery based on the delivery type and the setting contents of the targeting. If there is competition, the advertising content determining unit 405 determines the advertising content with the highest bid price as the advertising content to be delivered, in the auction. Here, according to the second price auction, the second highest bid price is registered as the charge in the advertisement DB 421.

Then, the advertisement link embedding unit 406 embeds a link of the advertising content determined by the advertising content determining unit 405 into an advertising space on the page generated by the page information generating unit 404 (step S109).

Next, the page sending unit 407 sends the page information to the requester, that is, the browser 31 of the terminal device 3 (step S110).

In response to the page information, the browser 31 of the terminal device 3 renders and displays a screen based on the page information (step S111), and requests the advertising content in the process, based on the link embedded in the advertising space (step S112).

When the advertisement request receiving unit 408 of the page information/advertising information providing device 4 receives the request for the advertising content, the advertisement sending unit 409 sends the data of the corresponding advertising content to the requester, that is, the browser 31 of the terminal device 3 (step S113). Note that when a page is displayed, an advertisement delivery server may receive a redirection of the advertisement request from the advertising space and deliver the advertising content.

Note that an arrangement for charging is not described, but, for example, the advertiser is charged for an advertising fee in a prescribed period of time (for example, one month as a unit).

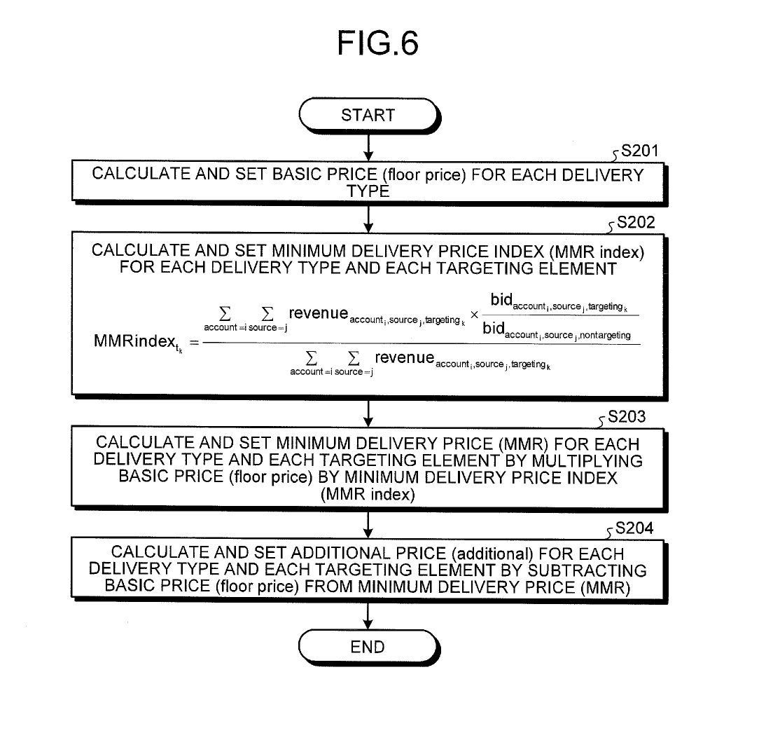

FIG. 6 is a flowchart illustrating a processing example of generating an MMR table (step S103 of FIG. 5).

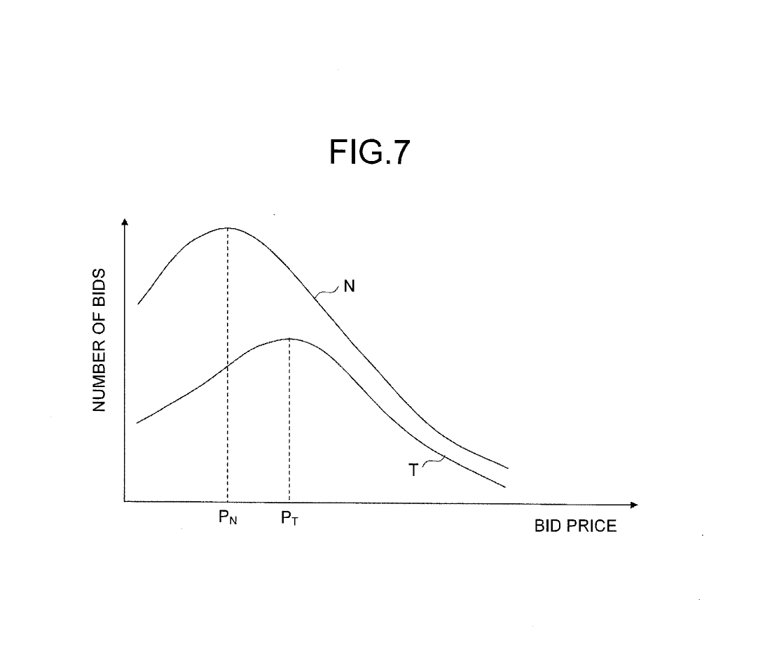

In FIG. 6, when processing is started, a basic price (floor price) is calculated for each delivery type and set into the NMR table 422 (step S201). FIG. 7 is a diagram illustrating a distribution example of bid prices. N indicates a relationship between the bid prices and the number of bids when the targeting is not performed. T indicates a relationship between the bid prices and the number of bids, for example, when the targeting is performed with “female” as the targeting element. Here, the basic price (floor price) corresponds to a mode P_{N} of a curve N in the case of not performing the targeting. The mode P_{N} can be obtained, for example, as a solution of the bid price to obtain the maximum, by approximating a distribution curve by an equation.

Referring back to FIG. 6, the minimum delivery price index (MMR index) is calculated for each delivery type and each targeting element by an illustrated equation, and set into the MMR table 422 (step S202). Here, tₖ and targetingₖ indicate prescribed targeting elements, accountᵢ indicates an advertiser, source_{d} indicates a delivery section, revenue indicates a charge, and bid indicates a bid price. Also, nontargeting indicates that a targeting is not to be performed. This equation implicates a ratio of the bid price in the case of performing the targeting to the bid price in the case of not performing the targeting, the ratio being normalized by the charge, for the prescribed targeting elements. Here, the ratio is normalized based on bid data of a plurality of (great number of) advertisers and delivery sections. The normalization by the charge is performed to prevent the minimum delivery price index from being influenced by outliers and to enhance accuracy of the minimum delivery price index. Generally, an account including a larger sales scale, which is the total charge, properly operates. Thus, the accuracy of the minimum delivery price index can be enhanced by changing the weight according to the sales scale.

In addition, the bid prices are different depending on scales of bidding advertisers (such as major client and small private store). Also in that case, the difference in the bid prices can be absorbed by the normalization. For example, in the case of
a major client “male” targeting: 100 yen, non-targeting: 50 yen
a small private store “male” targeting: 50 yen, non-targeting: 10 yen
   the small private store values the “male” targeting five times the non-targeting, but the major client values the “male” targeting twice the non-targeting. However, the price is higher in the major client. With the normalization described above, the weight of the bid price of the major client having a larger charge is increased, and bidding tendency of the major client appears stronger in the minimum delivery price index.

Next, for each delivery type and each targeting element, the minimum delivery price (MMR) is calculated by multiplying the basic price (floor price) by the minimum delivery price index (MMR index) and set into the MMR table 422 (step S203).

Then, for each delivery type and each targeting element, the additional price (additional) is calculated by subtracting the basic price (floor price) from the minimum delivery price (MMR) and set into the MMR table 422 (step S204).

Note that instead of using the minimum delivery price index (MMR index), as an easy method of calculating the minimum delivery price (MMR), the minimum delivery price (MMR) may be calculated by the distribution of bid prices illustrated, for example, in FIG. 7, although the accuracy is degraded. For example, first, the mode P_{N} (corresponding to basic price (floor price)) of the curve N in the case of not performing the targeting, and a mode P_{T} of a curve T in the case of performing the targeting are calculated. The modes P_{N} and P_{T} may be obtained, for example, as solutions of the bid prices to obtain the maximum, by respectively approximating distribution curves by equations. Then, by considering the difference between the mode P_{T} and the mode P_{N} as the additional price (additional), and adding the additional price (additional) to the basic price (floor price), the minimum delivery price (MMR) can be calculated.

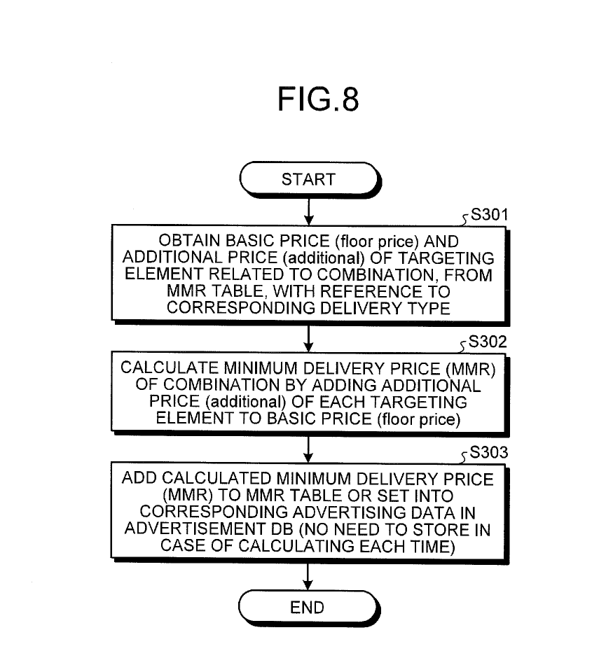

FIG. 8 is a flowchart illustrating a processing example of a combined MMR calculation (steps S104 and S107 of FIG. 5).

In FIG. 8, when processing is started, the basic price (floor price) and the additional price (additional) of targeting elements related to a combination are obtained from the MMR table 422 with regard to the corresponding delivery type (step S301).

Next, the minimum delivery price (MMR) of the combination is calculated by adding the additional price (additional) of each targeting element to the shared basic price (floor price) (step S302).

Then, the calculated minimum delivery price (MMR) is added to the MMR table 422 or set into the corresponding advertising data in the advertisement DB 421 (step S303). Note that when the minimum delivery price (MMR) is calculated each time, the calculated minimum delivery price (MMR) is not necessarily stored.

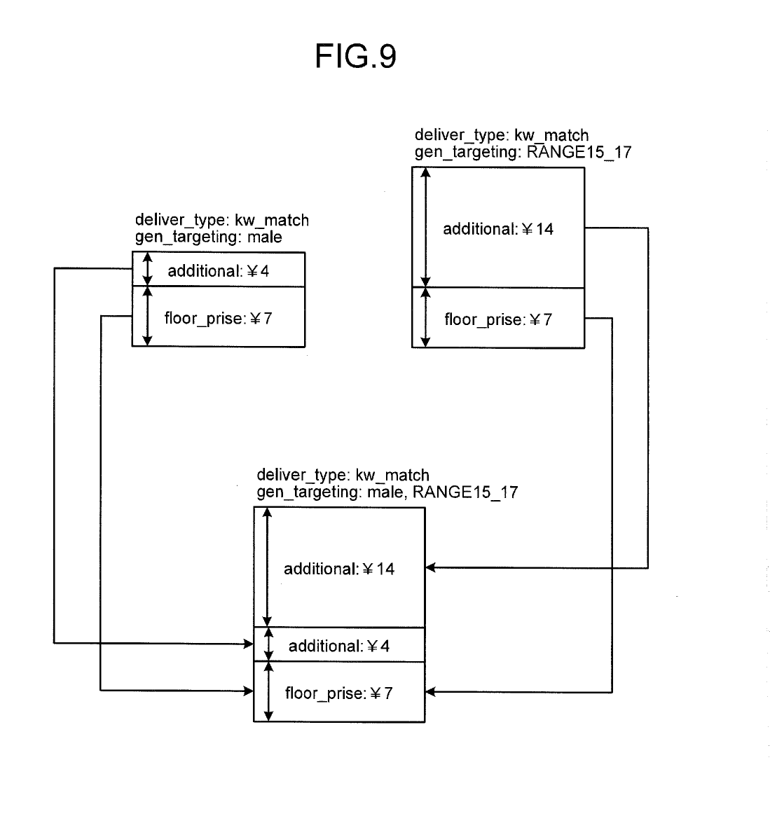

FIG. 9 is a diagram illustrating an example of the combined MMR calculation. An upper left part indicates that the basic price (floor price) is “¥7” and the additional price (additional) is “¥4” when the delivery type (deliver_type) is “kw_match” and the targeting element (gen_targeting) is “male”. An upper right part indicates that the basic price (floor price) is “¥7” and the additional price (additional) is “¥14” when the delivery type (deliver_type) is “kw_match” and the targeting element (gen_targeting) is “RANGE15_{—}17”.

Here, in a lower part, when the delivery type (deliver_type) is “kw_match” and the targeting element (gen_targeting) is a combination of “male” and “RANGE15_{—}17”, the minimum delivery price of the combination (combined MMR) can be calculated by adding the additional price (additional) of each of the corresponding targeting elements “¥4” and “¥14” to the shared basic price (floor price) “¥7”.

Conclusion

As described above, according to an embodiment of the present invention, value of using a targeting function is appropriately evaluated, delivery of advertising content whose bid price is deviant from a general bid price tendency can be limited, and a charge can be appropriately adjusted.

According to an embodiment of the present invention, value of using a targeting function can be appropriately evaluated, delivery of advertising content whose bid price is deviant from a general bid price tendency can be limited, and a charge can be appropriately adjusted.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertising charge adjusting device configured to set a minimum delivery price which determines a lower limit of a bid price, the advertising charge adjusting device comprising:
a minimum delivery price calculating unit configured to calculate the minimum delivery price for each targeting element, based on bid information for using a targeting function and bid information for not using the targeting function, pieces of bid information being submitted by a plurality of advertisers.

2. The advertising charge adjusting device according to claim 1, wherein the minimum delivery price calculating unit includes:
a first unit configured to calculate a basic price from a mode of distribution of the number of bids to the bid prices according to the bid information for not using the targeting function;
a second unit configured to calculate a minimum delivery price index which indicates a ratio of a bid price in the case of using the targeting function to a bid price in the case of not using the targeting function, with respect to a prescribed targeting element, based on bid information of a plurality of advertisers and delivery sections; and
a third unit configured to calculate the minimum delivery price by multiplying the basic price by the minimum delivery price index.

3. The advertising charge adjusting device according to claim 2, wherein the second unit calculates the minimum delivery price index by normalizing the bid price in the case of not using the targeting function and the bid price in the case of using the targeting function by respective charges thereof.

4. The advertising charge adjusting device according to claim 1, wherein the minimum delivery price calculating unit includes:
a fourth unit configured to calculate a basic price from a mode of distribution of the number of bids to the bid prices according to the bid information for not using the targeting function;
a fifth unit configured to calculate an additional price by subtracting the basic price from a mode of distribution of the number of bids to the bid prices according to the bid information for using the targeting function with respect to a prescribed targeting element; and
a sixth unit configured to calculate the minimum delivery price by adding the additional price to the basic price.

5. The advertising charge adjusting device according to claim 2, wherein when a plurality of targeting functions is combined, the minimum delivery price calculating unit calculates a minimum delivery price in the case where the plurality of targeting functions is combined, by summing the additional price, which is a difference between the minimum delivery price of the targeting element and the basic price, to a shared basic price corresponding to each of the targeting elements configuring the combination.

6. An advertising charge adjusting method for setting a minimum delivery price which determines a lower limit of a bid price, the advertising charge adjusting method comprising:
calculating the minimum delivery price for each targeting element, based on bid information for using a targeting function and bid information for not using the targeting function, both pieces of bid information being submitted by a plurality of advertisers.
